(19) United States
(12) Patent Application Publication
(10) Pub. No.: US 2002/0122574 A1
(43) Pub. Date: Sep. 5, 2002

(54) On-line signature verification of collectibles

(76) Inventor: Dan C. Morgan, San Jose, CA (US)

Correspondence Address: MOLLY D MCKAY, PC, 3207 E 22ND STREET, TULSA, OK, 74114-1823, US

(21) Appl. No.: 09/733,794

(22) Filed: Dec. 7, 2000

(51) Int. Cl. G06K 9/00

(52) U.S. Cl. 382/119

(57) ABSTRACT

A verification system for authenticating a suspected signature on a collectible object by scanning the suspected signature into an originating computer, electronically transmitting the image to a central computer where the suspected signature is compared with a set of authentic reference signatures stored there based on the user's input as to the shape of the object on which the suspected signature is inscribed. The central computer transmits to the originating computer an authentication of the suspected signature or an indication that the suspected signature can not be authenticated. Optionally, a printer can print a certificate of authentication bearing one of two identical serialized holograms and a second identical serialized hologram for attachment to the collectible.

### BACKGROUND OF THE INVENTION

1. Field of the Invention

The present invention relates to a method employing an on-line computer system for verifying or authenticating signatures of celebrities, artists, or athletes that have been scribed onto flat or irregularly shaped collectible objects.

2. Description of the Related Art

One of the problems faced by purchasers of collectibles that are inscribed with a signature of a celebrity, artist, or athlete is trying to determine whether the signature is authentic or forged. Until now there has not been a way for a purchaser to be able to have the signature authenticated quickly and accurately prior to purchasing the collectible. Currently consumers must first purchase a collectible item, deliver the item to a forensic signature specialist, and wait for a response. Such verification practice takes unnecessary time and can cost more than the collectible is worth. Also this practice involves risks associated with shipping. And verification by a forensic signature specialist is subject to human subjectiveness. Because the current practice of signature verification of signed collectibles is typically performed after purchase, if the signature is a forgery, the collector is left with a worthless item, causing legal battles and disappointment for the purchaser. Because dealers of signed collectibles are required by law to issue certificates of authenticity but are not required to obtain signature verification before the sale, the certificates of authenticity are often worthless.

Signature verification is available to financial institutions, but currently the signed collectible industry does not have similar verification methods available for its use. Also, current automatic signature verification is limited to two dimensional or flat items. No automatic signature verification provisions have been made for curved surfaces such as footballs, baseballs, or basketballs. Because there is not a convenient and automatic signature verification process for the collectible industry, this results in millions of dollar wasted annually on forged collectibles

The present invention is a verification system that allows a purchaser to scan the suspected signature into a personal computer, a portable computer, or a palm computer via either a desk top scanner, a hand held scanner, or a digital camera and to transmit the scanned suspected signature via the Internet to a central computer that is capable of comparing the suspected signature with authentic reference signatures and providing the purchaser with an immediate indication whether the suspected signature is authentic or not authentic. If the purchaser wants proof of verification, he may request a certificate of authenticity having a serialized hologram that is identical to a serialized hologram that is then permanently affixed to the collectible.

### SUMMARY OF THE INVENTION

The present invention is a verification system for authenticating a signature on a collectible quickly without having to transport the collectible. The suspected signature is scanned into an originating computer, i.e. either a personal computer, a portable computer, or a palm computer. A desk top scanner that is connected to the originating computer can be used for scanning flat collectibles such as photographs, or a hand held scanner that is connected to the originating computer can be used for scanning either flat objects or irregular shaped objects such as baseballs, footballs, basketballs, etc. Alternately, a digital camera may be used to scan the collectible with the image being entered into the originating computer from the camera. Then the suspected signature is electronically transmitted via the Internet to a central computer that is provided with software that compares the suspected signature with authentic reference signatures stored in the central computer. The central computer then immediately transmits to the originating computer an authentication of the signature or an indication that the suspected signature can not be authenticated.

If the purchaser wants proof of verification, he may request a certificate of authenticity having a serialized hologram that is identical to a serialized hologram that is then permanently affixed to the collectible.

### BRIEF DESCRIPTION OF THE DRAWINGS

FIGS. 1A, 1B, and 1C are a flow diagram of a method for online signature verification of collectibles according to a preferred embodiment of the present invention.

### DETAILED DESCRIPTION OF THE PREFERRED EMBODIMENT

### The Invention

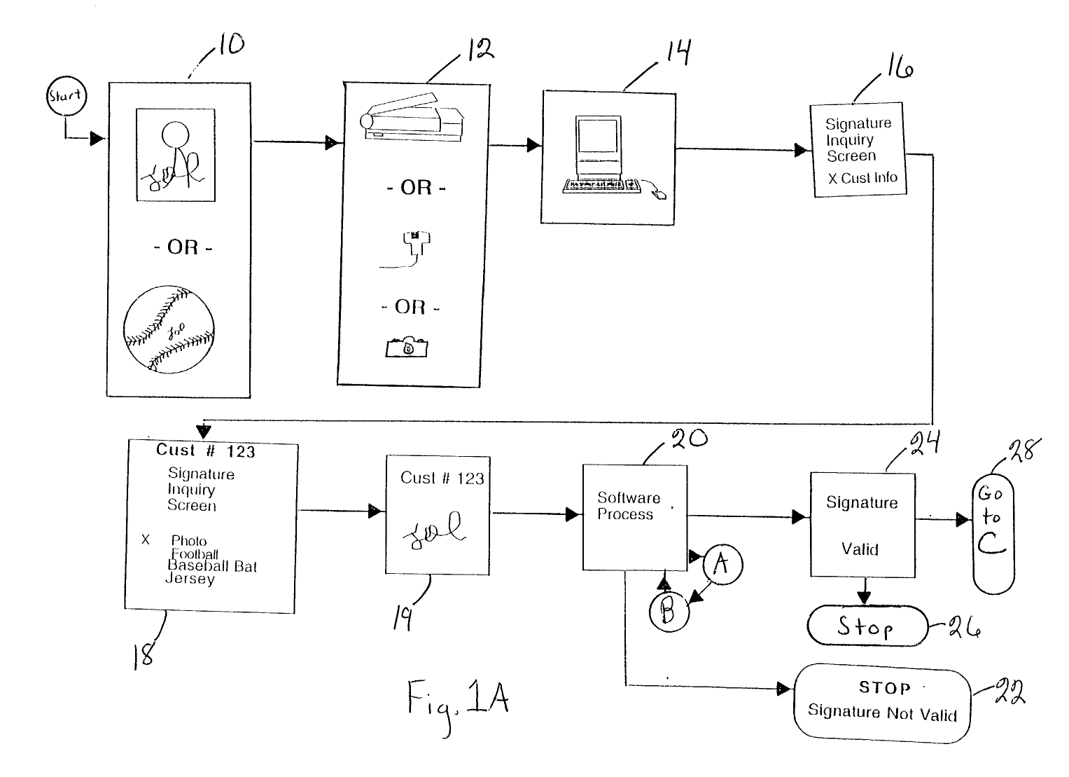

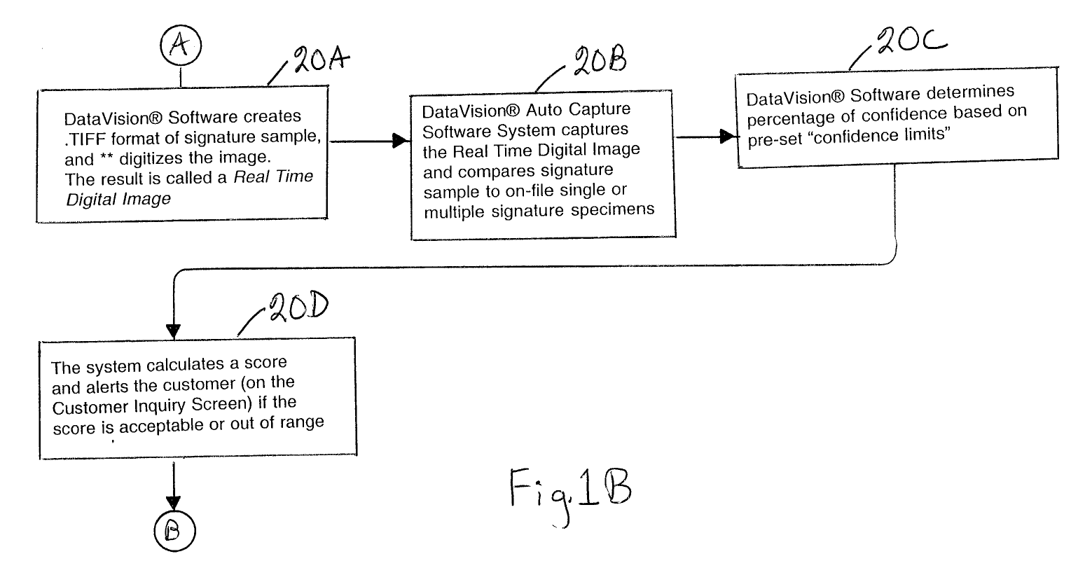

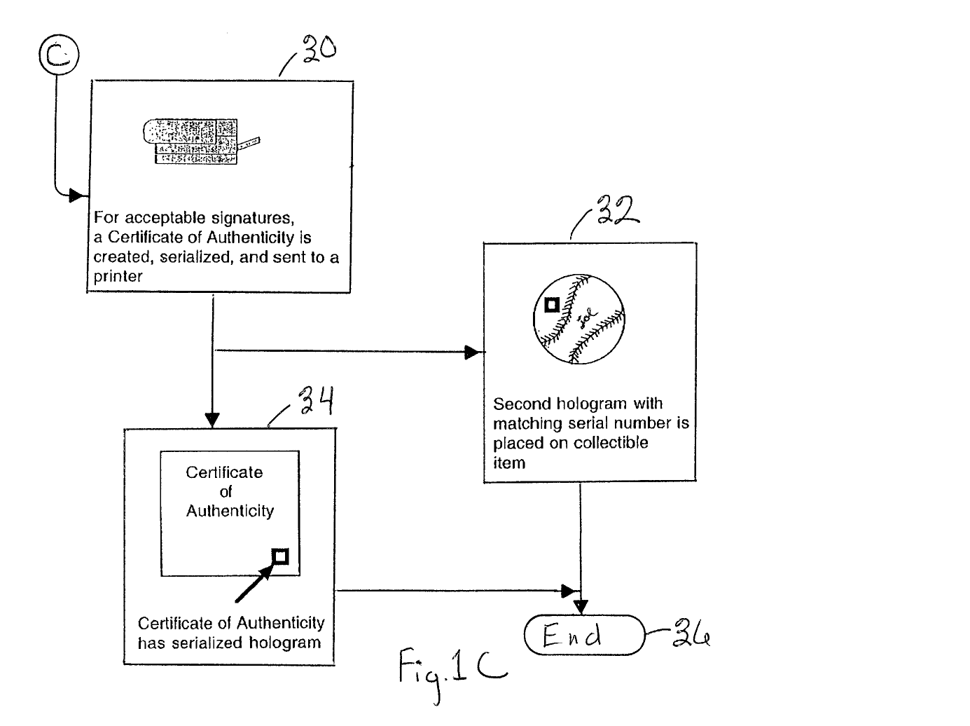

Referring now to the drawings and initially to FIG. 1A, there is illustrated a method of on-line signature verification of collectibles. As shown in box 10, the collectible may be either a flat object, such as a photograph or painting, or an irregular shaped object, such as a baseball, basketball, or football. The collectible is inscribed with a signature of a celebrity, artist, athlete or other famous person. The signature to be subjected to authentication will hereafter be referred to as the suspected signature.

As shown in boxes 12 and 14, the suspected signature is scanned via a scanner 12 into an originating computer 14, i.e. a personal computer, a portable computer, or a palm computer. The scanner 12 that is used will be a desk top scanner that is connected to the originating computer 14 for scanning flat collectibles, a hand held scanner that is connected to the originating computer for scanning either flat objects or irregular shaped object, or a digital camera from which the image can be entered into the originating computer 14. If the user of this system is an individual, the originating computer 14 and scanner 12 may be the user's personal computer at home or at work. On the other hand, if the user of this system is an agent that has previously contracted to serve as the authorized agent for authenticating collectibles according to this process, the originating computer 14 and scanner 12 will be located in the agent's place of business and the owner of the collectible 10 will bring the collectible to the agent's place of business for authentication.

Next, the user connects via the Internet to a central computer, as represented by the initial signature inquiry screen display of the central computer shown in box 16. The user fills out the requested customer information on the signature inquiry screen of box 16. Then, as shown in box 18, the user must select the type of object that bears the suspected signature that is to be authenticated and the person whose signature is to be authenticated. The computer has a number of reference signatures stored in memory for each signer, i.e. celebrity, artist, athlete, etc. By selecting the type of object that bears the suspected signature and the name of the signer whose signature is to be authenticated, the computer can match the set of reference signatures for the signer that most closely match the configuration of the object, i.e. flat, slightly curved, spherical, etc. This is important to match the configuration of the object to the appropriate set of reference signatures since a signature inscribed on a curved or spherical object with be slightly skewed and these skewed signatures must be compared with equally skewed reference signatures, i.e. reference signatures that are from similarly curved or spherical objects. As illustrated in box 19, the scanned image of the suspected signature is then transmitted from the originating computer 14 to the central computer 16.

As illustrated in box 20, the central computer 16 is provided with software that compares the suspected signature with the appropriate set of authentic signatures stored in the central computer for the designated individual, i.e. specified celebrity, artist or athlete for which a signature is to be verified. Referring now to FIG. 1B, the details of box 20 are further illustrated, beginning with box A and ending with box B. Box 20A shows that the software employed is DataVision® software. This software is available from Datavision at the following address: 63 County Road, North Falmouth, Mass. 02556. This software can be loaded onto the central computer 16, as illustrated in the drawings, or alternately can reside in an offsite computer that is accessible by the central computer 16 by the Internet or other appropriate real time connection. Although a particular brand of software has been specified, the invention is not so limited. Any suitable software can be use that will accomplish the desired result. Box 20A shows that the software creates a TIFF format of the suspected signature and digitizes the image. This results in what is referred to as a real time digital image. Box 20B shows that the software captures the real time digital image and compares the suspected signature sample to on-file single or multiple signature samples for the same signer. Box 20C shows that the software determines the percentage of confidence based on pre-set confidence limits. For example, the pre-set confidence limit might be set at 95% which means that the suspected signature must match the reference signature or signatures at a confidence level of 95% in order for the suspected signature to be authenticated by the system. As shown in box 20D, the system calculates a score and alerts the user or customer, via the customer inquiry screen, if the score is acceptable or out of range.

Referring now again to FIG. 1A, if the signature is out of range, box 22 shows that the process ends when the suspected signature is found to be invalid. On the other hand, if the suspected signature is valid, as show in box 24, the user may either stop the process, as indicated by box 26, or if the user is an agent for the process, the process can be continued at box C on FIG. 1C, as illustrated by box 28. All of this information is stored in the central computer 16 for retrieval at a future time.

If the user is an agent that has previously contracted to serve as the authorized agent for authenticating collectibles according to this process, the process continues at box C on FIG. 1C. For those signatures that are authenticated, a printer at the user's location, illustrated by box 30, produces a certificate of authenticity bearing a serialized hologram and a second identical serialized hologram for permanently attaching to the object that bears the authentic signature. All of this information is stored in the central computer 16 for retrieval at a future time.

The second hologram is affixed to the collectible to mark the collectible, as illustrated in box 32 and gives the marked collectible 32 and the certificate, as illustrated in box 34, to the owner of the collectible, thus ending the process, as shown by box 36.

Although not illustrated, it may be desirable for security purposes to again require that the marked collectible 32 be scanned again after the second hologram has been affixed to the collectible as a means of verifying that the second hologram has been properly affixed to the collectible.

While the invention has been described with a certain degree of particularity, it is manifest that many changes may be made in the details of construction and the arrangement of components without departing from the spirit and scope of this disclosure. It is understood that the invention is not limited to the embodiments set forth herein for the purposes of exemplification, but is to be limited only by the scope of the attached claim or claims, including the full range of equivalency to which each element thereof is entitled.

What is claimed is:

1. A method of verifying the authenticity of a signature on a collectible object comprising the following steps:
a. connecting an originating computer via an online communication system to a central computer,
b. providing information from the originating computer to the central computer about the user and the signer and selecting the type of collectible surface on which the suspected signature is inscribed,
c. scanning the suspected signature at the originating computer and transmitting the scanned image to the central computer,
d. comparing the scanned image of the suspected signature with a selected set of stored signatures at the central computer to determine whether the suspected signature is authentic or not authentic, and
e. communicating to the originating computer whether the signature is authentic or not authentic.

2. A method of verifying the authenticity of a signature on a collectible object according to claim 1 further comprising the following steps for those signatures that are determined to be authentic:
f. printing a certificate of authenticity bearing a serialized hologram and printing a second identical hologram for those signatures that are authentic, and
g. attaching the second hologram to the collectible.

3. A method of verifying the authenticity of a signature on a collectible object comprising the following steps:
a. scanning a suspected signature that is inscribed on a collectible with a scanner and transferring the scanned image into an originating computer,
b. connecting the originating computer via an online communication system to a central computer,
c. providing information from the originating computer to the central computer about the user and the signer and selecting the type of collectible surface on which the suspected signature is inscribed,
d. transmitting the scanned image from the originating computer to the central computer,
e. comparing the scanned image of the suspected signature with a selected set of stored reference signatures at the central computer to determine whether the suspected signature is authentic or not authentic, and
f. communicating to the originating computer whether the suspected signature is authentic or not authentic.

4. A method of verifying the authenticity of a suspected signature on a collectible object according to claim 3 further comprising the following steps for those suspected signatures that are determined to be authentic:
g. printing a certificate of authenticity bearing a serialized hologram and printing a second identical hologram for those suspected signatures that are authentic, and
h. attaching the second hologram to the collectible.
